(19) United States
(12) Patent Application Publication
(10) Pub. No.: US 2006/0260794 A1
(43) Pub. Date: Nov. 23, 2006

(54) Air conditioning installation for a passenger cell of a vehicle

(75) Inventors: Stefan Giez, Grafenau (DE); Markus Schoellhorn, Sindelfingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/529,580

(22) PCT Filed: Sep. 27, 2003
(86) PCT No.: PCT/EP03/10785

§ 371 Date: Dec. 16, 2005

(30) Foreign Application Priority Data
Oct. 2, 2002 (DE) 102 46 044.2

(51) Int. Cl. B60H 1/00

(52) U.S. Cl. 165/203

(57) ABSTRACT

The invention relates to an air conditioning installation for a passenger cell of a vehicle, said passenger cell having a rear area, with at least one air duct which leads to the rear area and is capable of being acted upon by air of preselectable temperature, and with at least one air outflow device connected to the air duct and arranged in the rear area. To simplify the rear area air conditioning in structural terms, with the aim of lowering the manufacturing costs, while maintaining air conditioning comfort in the rear area, the air duct has leading off from it a duct branch which is closed off by means of a second air outflow device arranged in the rear area, and at the branch point is arranged an air distribution member which allocates the air volume stream flowing in the air duct to the two air outflow devices. In this case, the air distribution member is designed in such a way that the allocation of the air volume stream takes place as a function of the “cooling” and “heating” operating modes of the air conditioning installation.

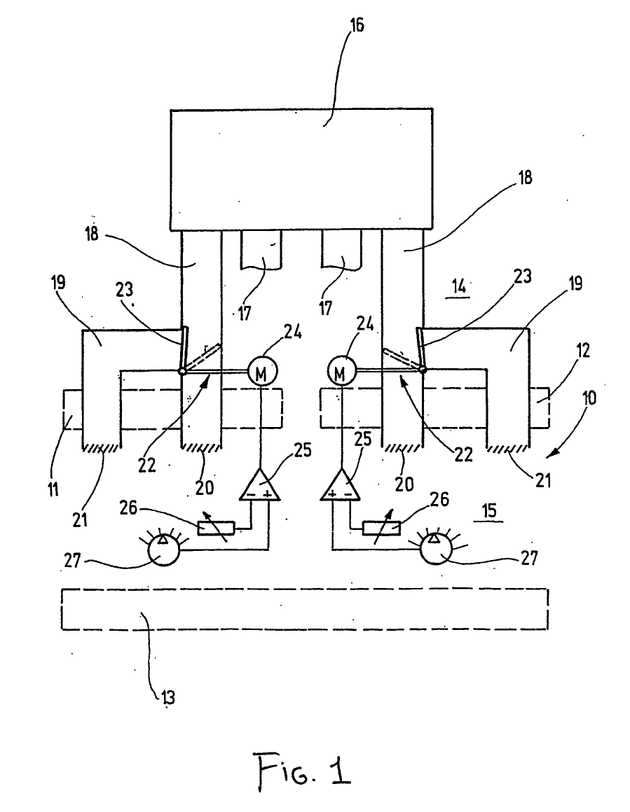

The invention relates to an air conditioning installation for a passenger cell of a vehicle, said passenger cell having a rear area, according to the preamble of patent claim 1.

In a known heating and air conditioning installation for a vehicle (DE 1 077 997 C2), behind each seat back of a fore or front seat, which together forwardly delimit the rear area of the passenger cell, is arranged an air distributor chamber which is connected in each case to an air duct. The two air ducts are laid on the floor of the passenger cell. The air flowing in each air duct is brought to the desired temperature in a heat exchanger. The two heat exchangers are arranged in each case on a door column in the front space of the passenger cell and have additional air outlet slots for ventilating the front space.

In a likewise known air conditioning installation (DE 196 46 123 A1), an air conditioning box has arranged in it an evaporator and a heat exchanger which have an air stream generated by a blower flow through them in the order mentioned. In the evaporator arranged in a refrigerant circuit, the air stream is cooled, and, in the heat exchanger arranged in the coolant circuit of the internal combustion engine of the vehicle, the air stream is heated up again. The heat exchanger is divided into four sectors, of which the two upper sectors are provided for heating the left and right half of the front space and the two lower sectors are provided for heating the right and left half of the rear area. The two lower sectors have emanating from them two pairs of air ducts, of which one pair leads to the left half of the rear area and one pair to the right half of the rear area. Each air duct is closed off by means of an air outflow device, of which, in each case in the left and right half of the rear area, one air outflow device is arranged in the foot space and the other air outflow device is arranged in the midplane of the rear area for the direct flow of air to the rear area passengers.

The object on which the invention is based is, while maintaining the same degree of air conditioning comfort, to simplify an air conditioning installation of the type initially mentioned in structural terms in the rear area, in order to lower the manufacturing costs.

The object is achieved, according to the invention, by means of the features of patent claim 1.

The air conditioning installation according to the invention has the advantage that only one air duct is required for routing the air to each half of the rear area, the allocation of the air-conditioned air, supplied to the rear area, to the foot space and to the midplane being maintained. In order to provide a pleasant space climate for the rear area passengers in spite of the air of equal temperature which flows into the foot space and into the midplane, there is provided in the air duct, at the branch point of the duct branch, an air distribution member which implements the allocation of air to the two air outflow devices as a function of the “heating” and “cooling” operating mode of the air conditioning installation. In this case, preferably, in the “cooling” operating mode the air quantity flowing into the foot space is sharply throttled or shut off completely and, in the “heating” operating mode, the greater air quantity is blown in via the foot space.

Advantageous embodiments of the air conditioning installation according to the invention, together with expedient developments and refinements of the invention, are specified in the further patent claims.

The invention is described in more detail below by means of an exemplary embodiment illustrated in the drawing. Thus, the drawing shows a diagrammatic illustration of an air conditioning installation for a passenger cell of a vehicle.

The air conditioning installation, reproduced only diagrammatically in the drawing, serves for the air conditioning of a passenger cell 10 of a vehicle, said passenger cell being equipped with two front or fore seats and with a rear area or back bench seat. Instead of the rear area bench seat, a plurality of individual or double seats may also be present. Of the front seats, only the seat backs 11 and 12 and, of the rear area bench seat, only the seat back 13 are indicated by broken lines. By virtue of the arrangement of the front seats, the passenger cell 10 is subdivided into a front space 14 and a rear area 15 which are capable of being air-conditioned individually by means of the air conditioning installation. In this case, an individual setting of the climate in the left and the right half of the passenger cell 10, both in the front space 14 and in the rear area 15, is provided.

The air conditioning installation has, in a known way, an air conditioning box 16, from which air ducts 17 for ventilating the front space 14 and air ducts 18 for ventilating the rear area 15 emanate. In each case one of the two air ducts 18 is routed respectively to the left and the right half of the rear area 15. As is known and is not illustrated any further here, the air conditioning box 16 has arranged in it an evaporator arranged in a refrigerant circuit, a heat exchanger arranged in the cooling water circuit of the internal combustion engine of the vehicle and an air distributor which follows the heat exchanger and by which the air cooled in the evaporator and heated in the heat exchanger is distributed to the air ducts 17, 18. The air stream flowing through the evaporator and the heat exchanger and flowing into the air distributor is generated by a blower which is arranged at the entrance of the air conditioning box 16 and which selectively sucks in fresh air from the vehicle surroundings or circulation air from the passenger cell and blows it into the air conditioning box 16. For the air conditioning of the rear area 15, two air outflow devices 20, 21 are provided in each half of the rear area 15, the air outflow device 20 being placed in the foot space and the air outflow device 21 being placed in the midplane for direct flow to the rear area passengers sitting on the rear area bench seat. The drawing illustrates the air outflow devices 21 next to the air outflow devices 20 for the sake of simplicity. In actual fact, however, they lie in a plane running above the plane of the air outflow devices 20. The air outflow devices 20 placed in the foot space close off the end of the air ducts 18 which issues in the rear area 15, while the air outflow devices 21 arranged in the midplane are in each case arranged at the issue end of a duct branch 19 emanating from the air duct 18. The branching off of the duct branches 15 is carried out as near as possible to the rear area end of the air ducts 18. At each branch point of the duct branch 19 is arranged an air distribution member 22 for allocating the air volume flowing in the air duct 18 to the two air outflow devices 20, 21. Each air distribution member 22 is in this case designed in such a way that the allocation of the air volume stream to the air outflow device 20 and the air outflow device 21 takes place as a function of the “cooling” and “heating” operating mode of the air conditioning installation. The allocation of the volume stream as a function of the operating mode is in this case such that, in the “cooling” operating mode, the air volume part stream arriving at the air outflow device 20 in the foot space is throttled very sharply to shut off almost completely. By contrast, in the “heating” operating mode, with an increase in the magnitude of the desired temperature of the air conditioning air, the air volume part stream arriving at the air outflow device 21 in the midplane is increasingly throttled.

In the exemplary embodiment described, the air distribution member 22 has an air flap 23 and a pivoting drive 24 which drives the air flap 23 and which brings the air flap 23 into a desired pivoting position between two end positions. In the end position of the air flap 23 which is illustrated by unbroken lines in the drawing, the duct branch 19 is closed off completely and the entire air volume stream is supplied to the air outflow device 20. In the end position of the air flap 23 which is illustrated by broken lines in the drawing, the duct branch 19 is opened completely and the air supply to the air outflow device 20 in the foot space is shut off completely. The pivoting drive 24 is designed as a servomotor which is activated by a comparator 25 used as a desired/actual-value comparator. The comparator 25 is connected on the input side to a temperature sensor 26 and to a temperature preselection element 27 and compares the desired temperature value set at the temperature preselection element 27 with the actual temperature value delivered by the temperature sensor 26. When the actual temperature value overshoots the desired temperature value, the air conditioning installation will operate in its “cooling” operating mode, and the pivoting drive 24 receives an actuation signal such that it sharply throttles the air volume part stream to the air outflow device 20 in the foot space, that is to say transfers the air flap 23 in the direction of the end position indicated by broken lines in the drawing. As is not illustrated any further here, the size of the desired/actual value difference may be utilized in order to determine the amount of throttling of the air volume part stream. If, by contrast, the desired temperature value set by means of the temperature preselection element 27 is higher than the actual temperature value delivered by the temperature sensor 26, an opposite actuation signal is applied to the pivoting drive 24 by the comparator 25. The pivoting drive 24 then pivots the air flap 23 in the direction of the end position illustrated by unbroken lines in the drawing, so that the air volume part stream which arrives at the air outflow device 21 placed in the midplane is throttled. The size of the desired/actual value difference may be utilized, here too, for fixing the amount of throttling of the air volume part stream arriving at the air outflow device 21.

Alternatively or additionally, the actuation signal for the pivoting drive may be generated or modified as a function of the ventilation temperature, so that the amount of throttling of the air volume part streams is determined by the ventilation temperature. As is not illustrated any further, the ventilation temperature may be detected directly in the air stream flowing in the air duct 18 or at another point of the air conditioning installation at which a temperature profile equivalent to that in the air duct 18 is present.

The invention is not restricted to the exemplary embodiment described. If an individual setting of the air conditioning in the left and the right half of the rear area 15 is dispensed with, and if there is a uniform air conditioning of the rear area 15, there is, of course, no need for a second air duct 18 with all the associated structural elements, so that they are present only once in the setup and context described. Of course, it is possible, in each rear area half, to arrange a plurality of air outflow devices 20 in the foot space and a plurality of air outflow devices 21 in the midplane, which are connected jointly to the same air duct 18 or duct branch 19.

1. An air conditioning installation for a passenger cell (10) of a vehicle, said passenger cell having a rear area (15), with at least one air duct (18) which leads to the rear area (15) and which can be acted upon by air of preselectable temperature, and with at least one air outflow device (20) which is connected to the air duct (18) and which is arranged in the rear area (15), characterized in that the air duct (18) has emanating from it a duct branch (19) which is closed off by means of a second air outflow device (21) arranged in the rear area (15) , in that at the branch point is arranged an air distribution member (22) for allocating the air volume flowing in the air duct (18) to the two air outflow devices (20, 21), and in that the air distribution member (22) is designed in such a way that the allocation of the air volume stream takes place as a function of the “cooling” and “heating” operating modes of the air conditioning installation.

2. The air conditioning installation as claimed in claim 1, characterized in that one air outflow device (20) is arranged in the foot space and the other air outflow device (21) is arranged in the midplane of the rear area (15), and in that the allocation of the air volume stream as a function of the operating mode is such that, in cooling operation, the air volume part stream arriving at the air outflow device (20) placed in the foot space is throttled.

3. The air conditioning installation as claimed in claim 2, characterized in that the allocation of the air volume stream as a function of the operating mode is additionally such that, in heating operation, the air volume part stream arriving at the air outflow device (21) placed in the midplane is throttled.

4. The air conditioning installation as claimed in claim 2 or 3, characterized in that the amount of throttling of the respective air volume part stream is carried out as a function of the temperature difference between an actual temperature and a preselected desired temperature.

5. The air conditioning installation as claimed in one of claims 2-4, characterized in that the amount of throttling of the respective air volume part stream is carried out as a function of a ventilation temperature.

6. The air conditioning installation as claimed in claim 5, characterized in that the ventilation temperature is picked up in the air conditioning installation directly from the air flowing in the air duct (18) or indirectly in a temperature range equivalent to this.

7. The air conditioning installation as claimed in one of claims 1-6, characterized in that the air distribution member (22) has an air flap (23), which is pivotable into two end positions in each case shutting off one of the air outflow devices (20, 21), and a pivoting drive (24) which drives the air flap (23) and which can be controlled via a temperature-influenced actuation signal (27).

8. The air conditioning installation as claimed in claim 7, characterized in that the actuation signal for the pivoting drive (24) is formed by the output signal from a desired/actual-value comparator (25) which compares a desired temperature set in a temperature preselection element (27) with the actual temperature measured in the rear area (15).

9. The air conditioning installation as claimed in claim 7 or 8, characterized in that the actuation signal for the pivoting drive is a function of the ventilation temperature.

10. The air conditioning installation as claimed in one of claims 1-9, characterized in that the branch point of the duct branch (19) lies near the rear area end of the air duct (18).
